(19) United States
(12) Patent Application Publication
(10) Pub. No.: US 2004/0135918 A1
(43) Pub. Date: Jul. 15, 2004

(54) Electronic device with image capture device

(76) Inventor: Chia-En Chuang, Tainan (TW)

Correspondence Address: QUINTERO LAW OFFICE, 1617 BROADWAY, 3RD FLOOR, SANTA MONICA, CA, 90404, US

(21) Appl. No.: 10/752,108

(22) Filed: Jan. 6, 2004

(30) Foreign Application Priority Data
Jan. 9, 2003 (TW) 92200381

(51) Int. Cl. H04N 5/225

(52) U.S. Cl. 348/335

(57) ABSTRACT

An electronic device with image capture device. The electronic comprises a body, a sensor, and a light-capturing portion. The sensor is disposed in the body. The light-capturing portion rotatably connects to the body and guides and projects an image to the sensor.

### BACKGROUND OF THE INVENTION

1. Field of the Invention

The present invention relates in general to an electronic device with image capture device. In particular, the present invention relates to an electronic device with image capture device which can capture images from different angles and directions without a complicated mechanism.

2. Description of the Prior Art

Currently, many mobile electronics, such as mobile phone, digital camera, and digital video camera, utilize many different designs to capture images from different angles and directions. For example, a sensor and a display are disposed on individual bodies, with a rotating apparatus disposed therebetween to capture images from different angles and directions.

FIG. 1 depicts a conventional mobile phone with image capturing device. The mobile phone comprises a body 11, a sensor 13, and a display 15. The sensor 13 is disposed on a rotating apparatus. When capturing images, rotating the body 11 aims at the subject. When the sensor 13 receives the image, the display 15 shows the image immediately.

As shown in FIG. 1, the conventional mobile phone cannot arbitrarily change angles and directions to capture images, a limitation of design. Thus, to capture images from different angles and directions, users must change physical location. Durable rotating apparatus of this type, between the sensor and the display, requires considerable cost and effort for design and manufacture.

Other disadvantages of conventional devices with image capture device can include danger of accidental damage to the exposed lens, and inability to change the lens.

### SUMMARY OF THE INVENTION

An object of the present invention is to provide an electronic device with image capture device in which a sensor and display are both disposed on a body. No complicated mechanism is necessary to achieve the purpose of capturing images from different angles and directions.

The present invention provides an electronic device with image capture device. The device comprises a body, a sensor, and a light-capturing portion. The sensor is disposed in the body. The light-capturing portion rotatably connects to the body, to guide and project an image to the sensor.

The present invention also provides another form of electronic device with image capture device, comprising a body, a sensor, a first light-capturing portion, and a second light-capturing portion. The sensor is disposed in the body. The first light-capturing portion and the second light-capturing portion are detachably and selectively connected to the body, to guide and project an image to the sensor.

### DESCRIPTION OF THE DRAWINGS

The present invention can be more fully understood by reading the subsequent detailed description in conjunction with the examples and references made to the accompanying drawings, wherein:

FIG. 1 is a schematic diagram showing a conventional mobile phone with image capturing device;

FIG. 2a is a schematic diagram showing an electronic device with image capture device of the present invention;

FIG. 2b shows a cross section of a light-capturing portion along IC-IC′ section line of FIG. 2a;

FIG. 3 is a schematic diagram showing another electronic device with image capture device of the present invention.

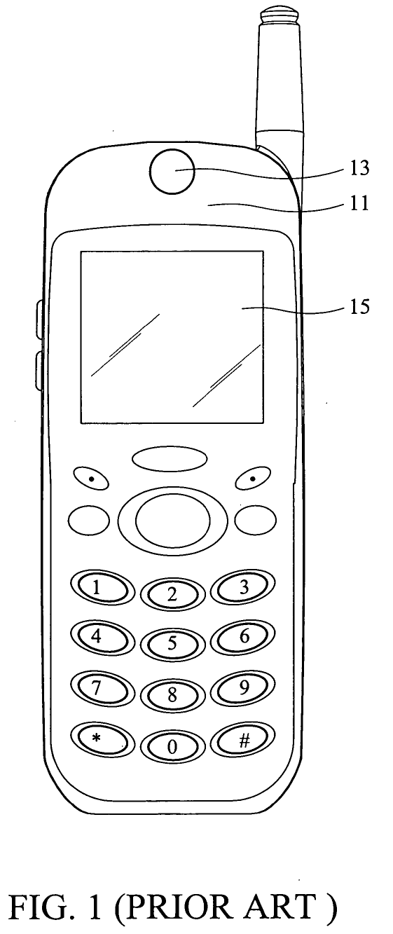

### DETAILED DESCRIPTION OF THE INVENTION

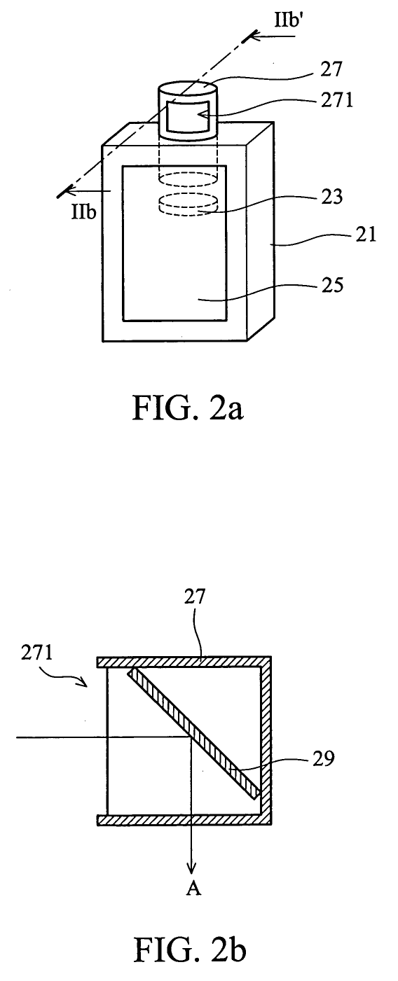

FIGS. 2a to 2c depict a first embodiment of an electronic device with image capture device. FIG. 2a is a schematic diagram showing an electronic device with image capture device according to the present invention. FIG. 2b shows a cross section of a light-capturing portion along IC-IC′ section line of FIG. 2a.

The present invention is an electronic device with image capture device. The device comprises a body 21, a sensor 23, and a light-capturing portion 27. The sensor 23 is a CCD or CMOS sensor.

The sensor 23 is disposed in the body 21. The light-capturing portion 27 rotatably connects to the body 21, to guide and project an image to the sensor 23. The light-capturing portion 27 has an aperture 271, and guides and projects the image to the light-capturing portion 27. A mirror 29 is disposed in the light-capturing portion 27 to reflect the image to the sensor 23. As shown in FIG. 2b, arrow A shows a path of the image from the subject, through the aperture 271, and reflecting to the sensor 23. Moreover, a display 25 is disposed on the body 21. When the sensor 23 receives the image, the display 25 shows the image through inner circuits (not shown). The image is stored, processed and transferred for further uses in other devices.

Furthermore, the light-capturing portion 27 extendably connects to the body. When capturing images, the light-capturing portion 27 protrudes from the body 21 to a first position. The light-capturing portion 27 is rotatably connected to the body 21 to receive the image. When the device is turned off, the light-capturing portion 27 is retracted into the body 21 to a second position. In the second position, the volume of the device is decreased, and accidental damage to the light-capturing portion 27 is avoided.

Moreover, the light-capturing portion 27 is rotatable through 360° to receive the image from different angles and directions.

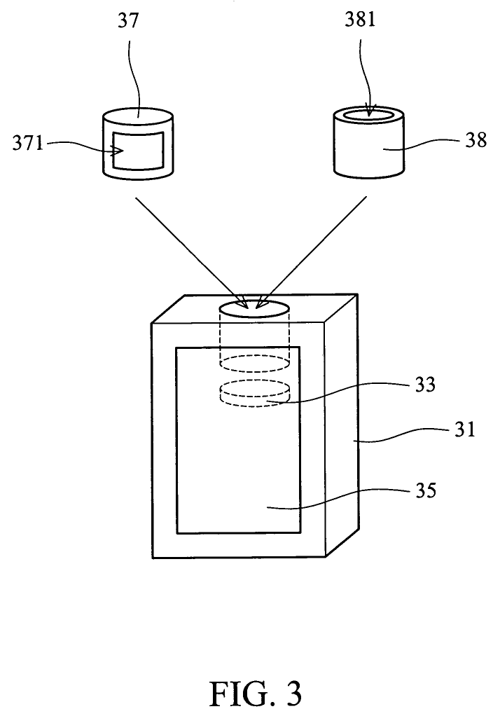

FIG. 3 depicts a second embodiment of an electronic device with image capture device. FIG. 3 is a schematic diagram showing an electronic device with image capture device according to the present invention.

The present invention is an electronic device with image capture device. The device comprises a body 31, a sensor 33, a first light-capturing portion 37, and a second light-capturing portion 38. The sensor 33 is a CCD or CMOS sensor.

The sensor 33 is disposed in the body 31. The first light-capturing portion 37 and the second light-capturing portion 38 are detachably and selectively connected to the body 31, to guide and project an image to the sensor 33. The first light-capturing portion 37 has a first aperture 371 and rotatably connects to the body 31. The first aperture 371 guides and projects the image to the first light-capturing portion 37. A mirror is disposed in the first light-capturing portion 37, to reflect the image to the sensor 33. The second light-capturing portion 38 has a second aperture 381 to guide the image thereto. Moreover, a display 35 is disposed on the body 31. When the sensor 33 receives the image, the display 35 shows the image through inner circuits (not shown).

The image is directed to the first light-capturing portion 37 through the first aperture 371 in a first direction when the first light-capturing portion 37 is connected to the body, and to the second light-capturing portion 38 through the second aperture 381 in a second direction when the second light-capturing portion 38 is connected to the body, and the first direction meets the second direction at a predetermined angle, such as 90°.

Furthermore, the first light-capturing portion 37 and the second light-capturing portion 38 are both extendably and selectively connected to the body. When capturing images, the first light-capturing portion 37 or the second light-capturing portion 38 protrudes from the body 31 to a first position. The first light-capturing portion 37 or the second light-capturing portion 38 is rotatably connected to the body 31 to receive the image. When the device is turned off, the first light-capturing portion 37 or the second light-capturing portion 38 is retracted into the body 31 to a second position. In the second position, the volume of the device is decreased and accidental damage to the first light-capturing portion 37 or the second light-capturing portion 38 is avoided.

The first light-capturing portion 37 and the second light-capturing portion 38 are both rotatable through 360° to receive the image from different angles and directions.

As mentioned above, advantages of the present invention include sensor and display being disposed directly on the body, simplifying the mechanism and eliminating the need for special rotating apparatus between the sensor and the display. Further, no complicated mechanism is necessary to capture images from different angles and directions, so volume of the device is decreased and design of the device is streamlined. 360° of image capture is available by merely rotating the light-capturing portion. Retraction of the light-capturing portion when not in use avoids accidental damage thereto, and the light-capturing portion can be changed easily.

Finally, when the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An electronic device with image capture device, comprising:
a body;
a sensor disposed in the body; and
a light-capturing portion rotatably connected to the body, guiding and projecting an image to the sensor.

2. The electronic device with image capture device as claimed in claim 1, wherein the light-capturing portion has a aperture guiding and projecting the image into the light-capturing portion.

3. The electronic device with image capture device as claimed in claim 1, further comprising a display disposed on the body, to show the image when the sensor receives the image.

4. The electronic device with image capture device as claimed in claim 1, further comprising a mirror disposed in the light-capturing portion, to reflect the image to the sensor.

5. The electronic device with image capture device as claimed in claim 1, wherein the light-capturing portion is extendably connected to the body, to receive the image when extended from body.

6. The electronic device with image capture device as claimed in claim 1, wherein the light-capturing portion is rotatable through 360°.

7. The electronic device with image capture device as claimed in claim 1, wherein the device is a mobile phone.

8. The electronic device with image capture device as claimed in claim 1, wherein the device is a digital camera.

9. The electronic device with image capture device as claimed in claim 1, wherein the device is a digital video camera.

10. The electronic device with image capture device as claimed in claim 1, wherein the device is a personal digital assistant (PDA).

11. An electronic device with image capture device, comprising:
a body;
a sensor disposed in the body;
a first light-capturing portion; and
a second light-capturing portion,
wherein the first light-capturing portion and the second light-capturing portion are detachably and selectively connected to the body, to guide and project an image to the sensor.

12. The electronic device with image capture device as claimed in claim 11, wherein the first light-capturing portion has a first aperture and the second light-capturing portion has a second aperture, the first and the second apertures project the image to the first and the second light-capturing portions, the image entering the first and second apertures at different directions, respectively.

13. The electronic device with image capture device as claimed in claim 11, further comprising a display disposed on the body, to show the image when the sensor receives the image.

14. The electronic device with image capture device as claimed in claim 11, further comprising a mirror disposed in the first light-capturing portion, to reflect the image to the sensor.

15. The electronic device with image capture device as claimed in claim 11, wherein the first and second light-capturing portions are extendably connected to the body, to receive the image when extended from the body.

16. The electronic device with image capture device as claimed in claim 11, wherein the first and second light-capturing portions are rotatable through 360°.

17. The electronic device with image capture device as claimed in claim 11, wherein the device is a mobile phone.

18. The electronic device with image capture device as claimed in claim 11, wherein the device is a digital camera.

19. The electronic device with image capture device as claimed in claim 11, wherein the device is a digital video camera.

20. The electronic device with image capture device as claimed in claim 11, wherein the device is a personal digital assistant (PDA).
